(19) United States
(12) Patent Application Publication
(10) Pub. No.: US 2025/0070176 A1
(43) Pub. Date: Feb. 27, 2025

(54) NEGATIVE ELECTRODE AND RECHARGEABLE LITHIUM BATTERY INCLUDING THE SAME

(71) Applicant: SAMSUNG SDI CO., LTD., Yongin-si (KR)

(72) Inventors: Ilyoung CHOI, Yongin-si (KR); Deok-Hyun KIM, Yongin-si (KR); Youngugk KIM, Yongin-si (KR)

(21) Appl. No.: 18/645,467

(22) Filed: Apr. 25, 2024

(30) Foreign Application Priority Data
Aug. 25, 2023 (KR) 10-2023-0112177

(51) Int. Cl. H01M 4/62; H01M 4/02; H01M 4/133; H01M 4/587; H01M 10/052

(52) U.S. Cl. CPC H01M 4/622; H01M 4/133; H01M 4/587; H01M 10/052; H01M 2004/027

(57) ABSTRACT

A negative electrode includes a current collector; and a negative electrode active material on the current collector, the negative electrode active material layer including a polymer having a potential band vs. Li of less than or equal to about 1.5 V, and a silicon active material, wherein the negative electrode has a binding force of greater than or equal to about 1.0 gf/mm and an electrical conductivity of about 1.0 S/m to about 6.0 S/m.

### CROSS-REFERENCE TO RELATED APPLICATION

This application claims priority to and the benefit of Korean Patent Application No. 10-2023-0112177 filed in the Korean Intellectual Property Office on Aug. 25, 2023, the entire contents of which are incorporated herein by reference.

### BACKGROUND

### 1. Field

Embodiments relate to negative electrodes and rechargeable lithium batteries including the same.

### 2. Description of the Related Art

Recently, with the rapid spread of electronic devices that use batteries, such as mobile phones, laptop computers, and electric vehicles, a demand for small, lightweight, and relatively high-capacity rechargeable lithium batteries is rapidly increasing. Accordingly, research and development for improving the performance of rechargeable lithium batteries is actively progressing.

Rechargeable lithium batteries may include a positive electrode and a negative electrode including an active material capable of intercalating and deintercalating lithium ions, and an electrolyte solution, and electrical energy is produced by oxidation and reduction reactions when lithium ions are intercalated/deintercalated at the positive and negative electrodes.

### SUMMARY

The embodiments may be realized by providing a negative electrode including a current collector; and a negative electrode active material on the current collector, the negative electrode active material layer including a polymer having a potential band vs. Li of less than or equal to about 1.5 V, and a silicon active material, wherein the negative electrode has a binding force of greater than or equal to about 1.0 gf/mm and an electrical conductivity of about 1.0 S/m to about 6.0 S/m.

The polymer may have a potential band vs. Li of less than or equal to about 1.5 V and greater than or equal to about 0.1 V.

The polymer may include polythiophene, poly(3,4-methylenedioxythiophene), polypyrrole, or a combination thereof.

An amount of the polymer may be about 30 wt % to about 85 wt %, based on a total weight of the negative electrode active material layer.

An amount of the polymer may be about 35 wt % to about 85 wt %, based on a total weight of the negative electrode active material layer.

An amount of the silicon active material may be about 15 wt % to about 70 wt %, based on a total weight of the negative electrode active material layer.

An amount of the silicon active material may be about 15 wt % to about 65 wt %, based on a total weight of the negative electrode active material layer.

The silicon active material may include a silicon material and an amorphous carbon coating layer on the silicon material.

The silicon material may include Si nanoparticles.

The silicon material may include Si, SiOₓ, in which 0<x≤2, or a combination thereof.

The silicon active material may include an agglomerated product in which silicon nanoparticles are agglomerated, and an amorphous carbon coating layer on a surface of the agglomerated product.

The amorphous carbon coating layer may include soft carbon, hard carbon, a mesophase pitch carbonized product, sintered coke, or a combination thereof.

The negative electrode may have a binding force of about 1.0 gf/mm to about 3.5 gf/mm.

The negative electrode may have an electrical conductivity of about 1.5 S/m to about 5.5 S/m.

The embodiments may be realized by providing a rechargeable lithium battery including the negative electrode according to an embodiment; a positive electrode including a positive electrode active material; and a non-aqueous electrolyte.

### BRIEF DESCRIPTION OF THE DRAWINGS

Features will be apparent to those of skill in the art by describing in detail exemplary embodiments with reference to the attached drawings in which:

FIGS. 1 to 4 are views schematically showing rechargeable lithium batteries according to some embodiments.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or element, it can be directly on the other layer or element, or intervening layers may also be present. In addition, it will also be understood that when a layer is referred to as being “between” two layers, it can be the only layer between the two layers, or one or more intervening layers may also be present. Like reference numerals refer to like elements throughout.

Unless otherwise specified in this specification, what is indicated in the singular may also include the plural. In addition, unless otherwise specified, “A or B” is not an exclusive term, and may mean “including A, including B, or including A and B”.

As used herein, “combination thereof” means a mixture, laminate, composite, copolymer, alloy, blend, reaction product, and the like of the constituents.

As used herein, when a definition is not otherwise provided, a particle diameter may be an average particle diameter. In addition, the particle diameter means the average particle diameter (D50), which means the diameter of particles having a cumulative volume of 50 volume % in the particle size distribution. The average particle size (D50) may be measured by a method well known to those skilled in the art, for example, by a particle size analyzer, a transmission electron microscopic image, or a scanning electron microscopic image. Alternatively, a dynamic light-scattering measurement device is used to perform a data analysis, and the number of particles is counted for each particle size range. From this, the average particle diameter (D50) value may be easily obtained through a calculation. Alternatively, it may be measured using a laser diffraction method. When measuring by the laser diffraction method, more specifically, the particles to be measured are dispersed in a dispersion medium, and then introduced into a commercially available laser diffraction particle diameter measuring device (e.g., Microtrac MT 3000), and ultrasonic waves of about 28 kHz with an output of 60 W are irradiated to calculate an average particle diameter (D50) on the basis of 50% of the particle diameter distribution in the measuring device.

A negative electrode according to some embodiments may include a current collector and a negative electrode active material layer on the current collector. The negative electrode active material layer may include, e.g., a polymer having a potential band vs. Li of less than or equal to about 1.5 V and a silicon negative electrode active material. The negative electrode may have a binding force of greater than or equal to about 1.0 gf/mm and an electrical conductivity of about 1.0 S/m to about 6.0 S/m.

The negative electrode active material layer may include only, e.g., may consist of, a silicon negative electrode active material and a polymer having a potential band of less than or equal to about 1.5 V vs. Li.

The polymer may have a potential band vs. Li of less than or equal to about 1.5 V, and a potential band vs. Li may be less than or equal to about 1.5 V and greater than or equal to about 0.1 V.

The polymer having the above-described potential bands may serve as a conductive material that receives lithium ions, and may also serve as a binder that allows silicon negative electrode active materials to adhere well to each other, and may help suppress volume expansion of the negative electrode active material, improving cycle-life characteristics. The polymer may also serve as an active material that reacts with lithium ions and participates in charge and discharge reactions.

In an implementation, the polymer may have a significant effect of suppressing volume expansion, and it may be more effective if used with an active material that has a large volume expansion during charging and discharging, e.g., a silicon negative electrode active material.

In an implementation, the negative electrode active material layer may include a polymer capable of suppressing volume expansion, high capacity may be effectively obtained by using a silicon active material without deterioration of cycle-life due to volume expansion, and capacity may also be obtained from the polymer.

In an implementation, the polymer may serve as a conductive material and a binder, there may be no need to use additional conductive materials and binders, and the negative electrode active material according to some embodiments may include or consist of only a silicon active material and a polymer.

Examples of the polymer may include polythiophene, poly(3,4-methylenedioxythiophene), polypyrrole, or a combination thereof. These polymers are environmentally friendly polymers.

In an implementation, an amount of the polymer may be, e.g., about 30 wt % to about 85 wt %, about 35 wt % to about 85 wt %, or about 39 wt % to about 81 wt %, based on a total weight of the negative electrode active material layer. Maintaining the amount of the polymer within the above ranges may help exhibit better binding force, may help suppress the volume expansion of the silicon active material more effectively, may help exhibit better cycle-life characteristics and better ionic conductivity, and may help implement a negative electrode that exhibits appropriate charge/discharge efficiency and better electrical conductivity.

In an implementation, an amount of the silicon active material may be, e.g., about 15 wt % to about 70 wt %, about 15 wt % to about 65 wt %, or about 19 wt % to about 61 wt %, based on a total weight of the negative electrode active material layer. Maintaining the amount of the silicon active material within the above ranges may help ensure that higher capacity is achieved.

In an implementation, the silicon active material may include a silicon material and an amorphous carbon coating layer on the silicon material.

In an implementation, the silicon material may include, e.g., Si, SiOₓ (0<x≤2), or a combination thereof. The Si may be Si nanoparticles.

In an implementation, the silicon active material may include an agglomerated product in which silicon nanoparticles are agglomerated, and an amorphous carbon coating layer on the surface of the agglomerated product.

In an implementation, a particle diameter of the silicon nanoparticles may be, e.g., about 10 nm to about 1,000 nm, about 10 nm to about 200 nm, or about 20 nm to about 150 nm. Maintaining the particle size of the silicon nanoparticles within the above ranges may help ensure that excessive volume expansion (which could otherwise occur during charging and discharging) is suppressed, and disconnection of the conductive path due to particle crushing during charging and discharging may be prevented.

In the amorphous carbon coating layer, the amorphous carbon may include, e.g., soft carbon, hard carbon, a mesophase pitch carbonized product, sintered coke, or a combination thereof. In an implementation, thickness of the amorphous carbon coating layer may be, e.g., about 1 nm to about 2 μm, about 1 nm to about 500 nm, about 10 nm to about 300 nm, or about 20 nm to about 200 nm. Maintaining the thickness of the amorphous carbon coating layer within the above ranges may help ensure that silicon volume expansion is well suppressed during charging and discharging.

In an implementation, the silicon-carbon composite may include silicon nanoparticles and an amorphous carbon coating layer, and an amount of the silicon nanoparticles may be, e.g., about 30 wt % to about 70 wt %, or about 40 wt % to about 65 wt %, based on a total weight of the silicon-carbon composite. In an implementation, the amount of the amorphous carbon coating layer may be, e.g., about 30 wt % to about 70 wt %, or about 35 wt % to about 60 wt %, based on a total weight of the silicon-carbon composite.

The current collector may include, e.g., a copper foil, a nickel foil, a stainless steel foil, a titanium foil, a nickel foam, a copper foam, a polymer substrate coated with a conductive metal, or a combination thereof.

The negative electrode according to some embodiments may have a binding force of greater than or equal to about 1.0 gf/mm, e.g., about 1.0 gf/mm to about 3.5 gf/mm, about 1.2 gf/mm to about 3.3 gf/mm, or about 1.5 gf/mm to about 3.0 gf/mm. In an implementation, the binding force of the negative electrode refers to the binding force between the current collector and the negative electrode active material layer. Maintaining the binding force of the negative electrode within the above ranges may help ensure that better cycle-life characteristics and a lower expansion rate may be exhibited. In an implementation, the binding force may be obtained by attaching a double-sided tape to the negative electrode and then measuring the 180° peeling strength using a tensile strength machine. The double-sided tape may be a double-sided tape coated with an acrylic adhesive, e.g., 3M 9346 paper double-sided tape.

The negative electrode according to some embodiments may have an electrical conductivity of, e.g., about 1.0 S/m to about 6.0 S/m, about 1.5 S/m to about 5.5 S/m, about 2.0 S/m to about 5.0 S/m, or about 3.0 S/m to about 6.0 S/m. Maintaining the electrical conductivity of the negative electrode within the above ranges may help ensure that better efficiency and output characteristics may be achieved.

### <Preparation of Negative Electrode>

The negative electrode according to some embodiments may be prepared by the following process.

The polymer having a potential band vs Li of less than or equal to about 1.5 V and silicon negative electrode active material may be added to a solvent to prepare a negative electrode active material layer composition. This solvent may be an organic solvent, e.g., N-methyl pyrrolidone.

A negative electrode may be manufactured by coating the negative electrode active material layer composition on a current collector and then drying, and pressing.

The coating, drying, and compressing processes may be performed under suitable negative electrode preparation conditions.

### <Rechargeable Lithium Battery>

Some embodiments provide a rechargeable lithium battery including a negative electrode, a positive electrode, and an electrolyte according to the above embodiment.

### [Positive Electrode]

The positive electrode may include a current collector and a positive electrode active material layer on the current collector.

The positive electrode active material layer may include a positive electrode active material and may further include a binder and/or a conductive material. In an implementation, the positive electrode may further include an additive that may serve as a sacrificial positive electrode.

The positive electrode active material may include lithiated intercalation compounds that reversibly intercalate and deintercalate lithium ions. In an implementation, a composite oxide of lithium and a metal, e.g., cobalt, manganese, nickel, or combinations thereof, may be used.

The composite oxide may be a lithium transition metal composite oxide, e.g., lithium nickel oxide, lithium cobalt oxide, lithium manganese oxide, lithium iron phosphate compound, cobalt-free nickel-manganese oxide, or a combination thereof.

In an implementation, the following compounds represented by any one of the following chemical formulas may be used. LiₐA_{1-b}X_{b}O_{2-c}D′_{c} (0.90≤a≤1.8, 0≤b≤0.5, and 0≤c≤0.05); LiₐMn_{2-b}X_{b}O_{4-c}D′_{c} (0.90≤a≤1.8, 0≤b≤0.5, and 0≤c≤0.05); LiₐNi_{1-b-c}Co_{b}X_{c}O_{2-α}D′_{α} (0.90≤a≤1.8, 0≤b≤0.5, 0≤c≤0.5, and 0≤c≤2); LiₐNi_{1-b-c}Mn_{b}X_{c}O_{2-α}D′_{α} (0.90≤a≤1.8, 0≤b≤0.5, 0≤c≤0.5, and 0≤c≤2); LiₐNi_{b}Co_{c}L¹_{d}GₑO₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃ (0≤f≤2); or LiₐFePO₄ (0.90≤a≤1.8).

In the above chemical formulas, A may be Ni, Co, Mn, or a combination thereof; X may be Al, Ni, Co, Mn, Cr, Fe, Mg, Sr, V, a rare earth element or a combination thereof; D′ may be O, F, S, P, or a combination thereof; G may be Al, Cr, Mn, Fe, Mg, La, Ce, Sr, V, or a combination thereof; and L¹ may be Mn, Al, or a combination thereof.

In an implementation, the positive electrode active material may be may be a high nickel positive electrode active material having a nickel amount of, e.g., greater than or equal to about 80 mol %, greater than or equal to about 85 mol %, greater than or equal to about 90 mol %, greater than or equal to about 91 mol %, or greater than or equal to about 94 mol % and less than or equal to about 99 mol %, based on 100 mol % of the metal excluding lithium in the lithium transition metal composite oxide. The high-nickel positive electrode active material may help realize high capacity and may be applied to a high-capacity, high-density rechargeable lithium battery.

In the positive electrode, an amount of the positive electrode active material may be about 90 wt % to about 98 wt %, based on a total weight of the positive electrode active material layer. Each amount of the binder and the conductive material may be 1 wt % to 5 wt %, based on a total weight of the positive electrode active material layer.

The binder may help attach the positive electrode active material particles to each other and also to well attach the positive electrode active material to the current collector. Examples of the binder may include polyvinyl alcohol, carboxymethyl cellulose, hydroxypropyl cellulose, diacetyl cellulose, polyvinylchloride, carboxylated polyvinylchloride, polyvinyl fluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like.

The conductive material may help impart conductivity to the electrode, and a suitable material that does not cause chemical change and conducts electrons may be used in the battery. Examples of the conductive material may include a carbon material such as natural graphite, artificial graphite, carbon black, acetylene black, ketjen black, a carbon fiber, a carbon nanofiber, or carbon nanotube; a metal material containing copper, nickel, aluminum, silver, etc., in a form of a metal powder or a metal fiber; a conductive polymer such as a polyphenylene derivative; or a mixture thereof.

The current collector may include, e.g., Al.

### [Electrolyte Solution]

The electrolyte solution may include a non-aqueous organic solvent and a lithium salt.

The non-aqueous organic solvent may serve as a medium for transmitting ions taking part in the electrochemical reaction of a battery.

The non-aqueous organic solvent may include a carbonate, ester, ether, ketone, alcohol, aprotic solvent, or a combination thereof.

The carbonate solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), or the like. The ester solvent may include methyl acetate, ethyl acetate, n-propyl acetate, dimethyl acetate, methyl propionate, ethyl propionate, decanolide, mevalonolactone, valerolactone, caprolactone, or the like. The ether solvent may include dibutyl ether, tetraglyme, diglyme, dimethoxyethane, 2-methyltetrahydrofuran, 2,5-dimethyltetrahydrofuran, tetrahydrofuran, or the like. The ketone solvent may include cyclohexanone or the like. The alcohol solvent may include ethanol, isopropyl alcohol, or the like. The aprotic solvent may include nitriles such as R—CN (wherein R is a C2 to C20 linear, branched, or cyclic hydrocarbon group, and may include a double bond, an aromatic ring, or an ether bond, or the like; amides such as dimethylformamide; dioxolanes such as 1,3-dioxolane, 1,4-dioxolane, or the like; sulfolanes, or the like.

The non-aqueous organic solvents may be used alone or in combination of two or more.

In an implementation, a carbonate solvent may be used, and a cyclic carbonate and a chain carbonate may be mixed and used, and the cyclic carbonate and the chain carbonate may be mixed in a volume ratio of about 1:1 to about 1:9.

The lithium salt dissolved in the organic solvent may supply lithium ions in a battery, may enable a basic operation of a rechargeable lithium battery, and may help improve transportation of the lithium ions between positive and negative electrodes. Examples of the lithium salt may include LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LIN (CₓF₂ₓ₊₁SO₂)(C_{y}F_{2y+1}SO₂) (wherein x and y are integers of 1 to 20), lithium trifluoromethane sulfonate, lithium tetrafluoroethane sulfonate, lithium difluorobis(oxalato)phosphate (LiDFOB), and lithium bis(oxalato)borate (LiBOB).

### [Separator]

Depending on the type of the rechargeable lithium battery, a separator may be present between the positive electrode and the negative electrode. The separator may include, e.g., polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, or the like.

The separator may include a porous substrate and a coating layer including an organic material, an inorganic material, or a combination thereof on one or both surfaces of the porous substrate.

The porous substrate may be a polymer film formed of, e.g., polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, or polytetrafluoroethylene, or a copolymer or mixture of two or more thereof.

The organic material may include a polyvinylidene fluoride polymer or a (meth)acrylic polymer.

The inorganic material may include inorganic particles, e.g., Al₂O₃, SiO₂, TiO₂, SnO₂, CeO₂, MgO, NiO, CaO, GaO, ZnO, ZrO₂, Y₂O₃, SrTiO₃, BaTiO₃, Mg (OH) 2, boehmite, or a combination thereof.

The organic material and the inorganic material may be mixed in one coating layer, or a coating layer including an organic material and a coating layer including an inorganic material may be stacked.

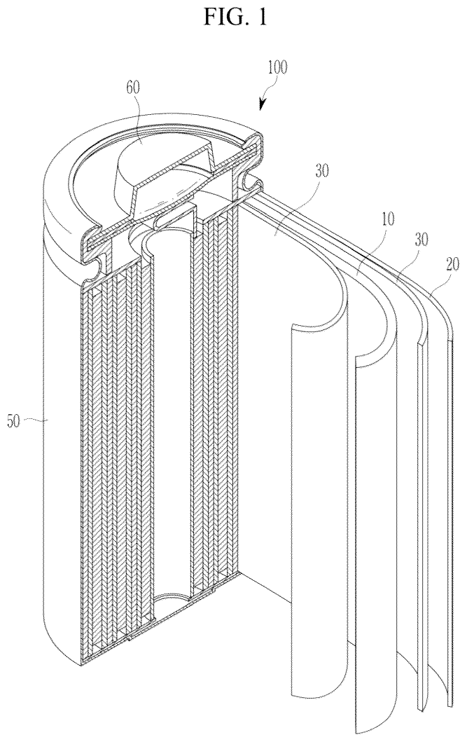

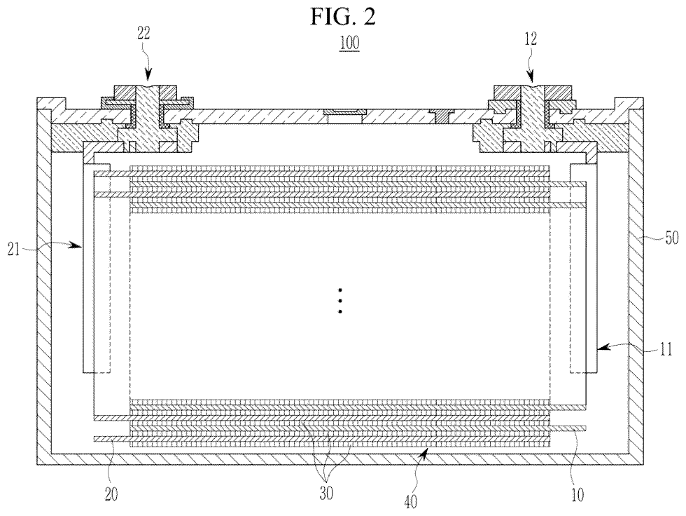

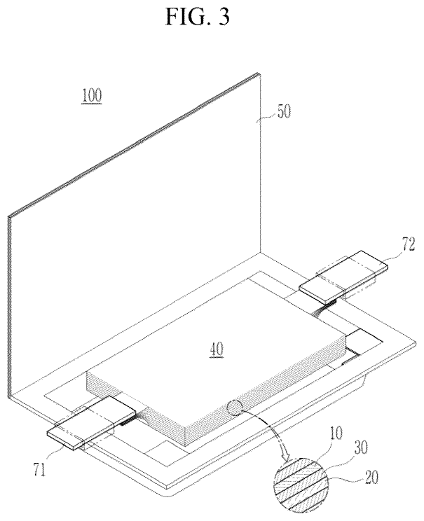

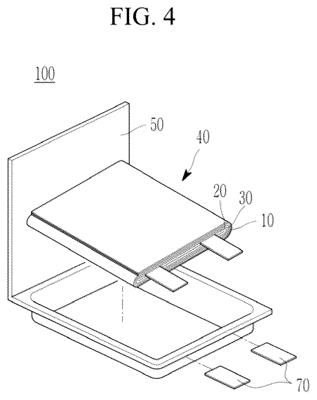

The rechargeable lithium battery may be classified into cylindrical, prismatic, pouch, coin, and the like depending on their shape. FIGS. 1 to 4 are schematic views illustrating a rechargeable lithium battery according to an embodiment. FIG. 1 shows a cylindrical battery, FIG. 2 shows a prismatic battery, and FIGS. 3 and 4 show pouch-type batteries. Referring to FIGS. 1 to 4, the rechargeable lithium battery 100 may include an electrode assembly 40 including a separator 30 between a positive electrode 10 and a negative electrode 20, and a case in which the electrode assembly 40 is housed. The positive electrode 10, the negative electrode 20, and the separator 30 may be impregnated with an electrolyte solution. The rechargeable lithium battery 100 may include a sealing member 60 sealing the case 50 as shown in FIG. 1. In addition, in FIG. 2, the rechargeable lithium battery 100 may include a positive lead tab 11, a positive terminal 12, a negative lead tab 21, and a negative terminal 22. As shown in FIGS. 3 and 4, the rechargeable lithium battery 100 may include an electrode tab 70, e.g., a positive electrode tab 71 and a negative electrode tab 72 serving as an electrical path for inducing the current formed in the electrode assembly 40 to the outside.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

19 wt % of a silicon-carbon composite and 81 wt % of polythiophene (0.5 V of a potential band vs. Li) were mixed in a water solvent to prepare negative electrode active material layer slurry.

The silicon-carbon composite included an agglomerated product of silicon nano particles with an average particle diameter (D50) of 100 nm were agglomerated and a soft carbon coating layer formed thereon. An amount of the silicon nano particles was 54 wt % based on a total weight of the silicon-carbon composite, an amount of the soft carbon was 46 wt %, and the soft carbon coating layer had a thickness of 100 nm.

The negative electrode active material layer slurry was coated on a Cu foil current collector and then, dried and pressed to prepare a negative electrode having a negative electrode active material layer.

The negative electrode was used with a lithium metal counter electrode and an electrolyte to fabricate a half-cell. The electrolyte was a 1.5 M LiPF₆ solution in a mixed solvent of ethylene carbonate, ethylmethyl carbonate, and dimethyl carbonate (in a volume ratio of 20:10:70).

### Example 2

A negative electrode and a half-cell were prepared in the same manner as in Example 1 except that 20 wt % of the silicon-carbon composite and 80 wt % of polythiophene were mixed in a water solvent to prepare negative electrode active material layer slurry.

### Example 3

A negative electrode and a half-cell were prepared in the same manner as in Example 1 except that 30 wt % of the silicon-carbon composite and 70 wt % of polythiophene were mixed in a water solvent to prepare negative electrode active material layer slurry.

### Example 4

A negative electrode and a half-cell were prepared in the same manner as in Example 1 except that 40 wt % of the silicon-carbon composite and 60 wt % of polythiophene were mixed in a water solvent to prepare negative electrode active material layer slurry.

### Example 5

A negative electrode and a half-cell were prepared in the same manner as in Example 1 except that 50 wt % of the silicon-carbon composite and 50 wt % of polythiophene were mixed in a water solvent to prepare negative electrode active material layer slurry.

### Example 6

A negative electrode and a half-cell were prepared in the same manner as in Example 1 except that 60 wt % of the silicon-carbon composite and 40 wt % of polythiophene were mixed in a water solvent to prepare negative electrode active material layer slurry.

### Example 7

A negative electrode and a half-cell were prepared in the same manner as in Example 1 except that 61 wt % of the silicon-carbon composite and 39 wt % of polythiophene were mixed in a water solvent to prepare negative electrode active material layer slurry.

### Example 8

A negative electrode and a half-cell were prepared in the same manner as in Example 1 except that 20 wt % of SiOₓ (x=2) and 80 wt % of polythiophene were mixed in a water solvent to prepare negative electrode active material layer slurry.

### Comparative Example 1

A negative electrode and a half-cell were prepared in the same manner as in Example 1 except that 97 wt % of a negative electrode active material (prepared by mixing the Si-carbon composite and polythiophene in a weight ratio of 15:85), 1 wt % of carbon black, 1 wt % of a styrene-butadiene rubber, and 1 wt % of carboxymethyl cellulose were mixed in a water solvent to prepare negative electrode active material layer slurry.

Except for using the negative electrode active material layer slurry, a negative electrode and a half-cell were manufactured in the same manner as in Example 1.

### Comparative Example 2

A negative electrode and a half-cell were m prepared in the same manner as in Example 1 except that 97 wt % of a negative electrode active material of a mixture of SiOₓ (x=2) and polythiophene (in a weight ratio of 15:85 between the Si-carbon composite and the polythiophene), 1 wt % of carbon black, 1 wt % of a styrene-butadiene rubber, and 1 wt % of carboxymethyl cellulose were mixed in a water solvent to prepare negative electrode active material layer slurry.

Except for using the negative electrode active material layer slurry, a negative electrode and a half-cell were manufactured in the same manner as in Example 1.

### Comparative Example 3

A negative electrode and a half-cell were prepared in the same manner as in Example 1 except that 78 wt % of the Si-carbon composite of Example 1 as a negative electrode active material, 19 wt % of polythiophene, 1 wt % of a carbon black conductive material, 1 wt % of a styrene-butadiene rubber binder, and 1 wt % of a carboxymethyl cellulose thickener were mixed in a water solvent to prepare negative electrode active material layer slurry.

Except for using the negative electrode active material layer slurry, a negative electrode and a half-cell were manufactured in the same manner as in Example 1.

### Comparative Example 4

A negative electrode and a half-cell were prepared in the same manner as in Example 1 except that 78 wt % of SiOₓ (x=2) as a negative electrode active material, 19 wt % of polythiophene, 1 wt % of a carbon black conductive material, 1 wt % of a styrene-butadiene rubber binder, and 1 wt % of a carboxymethyl cellulose thickener were mixed in a water solvent to prepare negative electrode active material layer slurry.

Except for using the negative electrode active material layer slurry, a negative electrode and a half-cell were manufactured in the same manner as in Example 1.

An amount of the Si-carbon composite or SiOₓ (x=2) (an amount of an Si material) and an amount of the polythiophene included in the negative electrode active material layers of Examples 1 to 8 and Comparative Examples 1 to 4 are shown in Table 1.

### Experimental Example 1) Evaluation of Binding Force

The negative electrodes of Examples 1 to 8 and Comparative Examples 1 to 4 were measured with respect to a binding force as follows.

First, the manufactured negative electrodes were cut into a size of a width of 25 mm and a length of 100 mm. A double-sided adhesive tape with a width of 20 mm and a length of 40 mm (a paper double-sided adhesive tape 3M 9346) was adhered to an acrylic plate with a width of 40 mm and a length of 100 mm. After attaching each of the prepared electrodes onto the double-sided adhesive tape, slightly pressing it 5 times with a hand roller, and mounting it on UTM (20 kgf Load cell) to peel off one end of the negative electrode by about 25 mm, the negative electrode was fixed onto a top clip of a tensile strength machine, while the tape adhered onto one side of the negative electrode was fixed onto a bottom clip, and then, measured with respect to 180° peeling strength, while peeling them apart at 100 mm/min. The results are shown as a binding force in Table 1.

### Experimental Example 2) Electrical Conductivity Evaluation

The negative electrodes of Examples 1 to 8 and Comparative Examples 1 to 4 were measured with respect to electrical conductivity as follows.

After sampling each of the negative electrodes into 10Φ (a diameter: 10 mm), electrical conductivity of the sample was measured, while applying a torque of 10 N·m at room temperature (25° C.), by using electrical resistance spectroscopy. Herein, frequencies from 500 kHz to 50 mHz were scanned by using an amplitude of 50 mV at an open circuit potential.

The results are shown in Table 1.

### Experimental Example 3) Cycle-Life Characteristic Evaluation

The half-cells of Examples 1 to 8 and Comparative Examples 1 to 4 were charged and discharged at 1 C 50 times within a range of 0.01 V to 1.5 V. The charge and discharge and their cut-off were performed under the following conditions.

Charge: constant current/constant voltage, 0.01 V/0.01 C cut-off

Discharge: constant current, 1.5 V cut-off

A ratio of 50^{th} discharge capacity to 1^{st} discharge capacity was calculated. The results are shown in Table 1.

### Experimental Example 4) Evaluation of Expansion Rate

The half-cells of Examples 1 to 8 and Comparative Examples 1 to 4 were charged and discharged 50 times at 1 C to SOC (State of Charge) 100 (a state of charging a battery cell up to 100% of charge capacity, if its total charge capacity was 100% during the charge and discharge within a range of 0.01 V to 1.5 V, that is, a full-charge state).

After the charge and discharge, the cells were disassembled to remove the negative electrodes. A thickness (an initial thickness) of the negative electrodes before the charge and discharge and a thickness of the negative electrodes after the 50th charge and discharge were measured. The results are used to calculate an expansion rate according to Equation 1. The obtained results are shown in Table 1.

Expansion rate (%)={(thickness after charge/discharge−initial thickness)/initial thickness}*100 [Equation 1]

TABLE 1

| | | | Binding | Electrical | Capacity | |
|---|---|---|---|---|---|---|
| | Si material | Polythiophene | force | conductivity | retention rate | Expansion rate |
| | (wt %) | (wt %) | (gf/mm) | (S/m) | (%) | (%) |
| Example 1 | 19 | 81 | 3.01 | 5.7 | 95.3 | 4.5 |
| Example 2 | 20 | 80 | 2.72 | 5.5 | 95.9 | 4.9 |
| Example 3 | 30 | 70 | 2.47 | 4.9 | 96.7 | 5.3 |
| Example 4 | 40 | 60 | 1.95 | 4.5 | 98.2 | 5.8 |
| Example 5 | 50 | 50 | 1.52 | 4.0 | 97.8 | 6.1 |
| Example 6 | 60 | 40 | 1.23 | 3.6 | 96.9 | 6.5 |
| Example 7 | 61 | 39 | 1.01 | 3.4 | 96.3 | 6.9 |
| Example 8 | 20 | 80 | 2.52 | 5.3 | 96.1 | 5.0 |
| Comparative | 14.6 | 82.4 | 3.21 | 2.5 | 93.2 | 4.2 |
| Example 1 | | | | | | |
| Comparative | 14.6 | 82.4 | 3.12 | 2.2 | 92.7 | 4.1 |
| Example 2 | | | | | | |
| Comparative | 78 | 19 | 0.81 | 1.7 | 92.3 | 8.8 |
| Example 3 | | | | | | |
| Comparative | 78 | 19 | 0.75 | 1.3 | 92.1 | 8.3 |
| Example 4 | | | | | | |

As shown in Table 1, the cells of Examples 1 to 8 including the Si-carbon composite or SiOₓ (x=2) and the polythiophene alone in the negative electrodes exhibited excellent binding force, electrical conductivity, and capacity retention rate, and a low expansion rate.

On the contrary, the cells of Comparative Examples 1 and 2 (all including the Si-carbon composite or SiOₓ (x=2), polythiophene, a carbon black, styrene-butadiene rubber, and carboxymethyl cellulose) exhibited a high binding force and a low expansion rate but low electrical conductivity and capacity retention.

The cells of Comparative Examples 3 and 4 (all including the Si-carbon composite or SiOₓ (x=2), polythiophene, carbon black, a styrene-butadiene rubber, and carboxymethyl cellulose and also polythiophene in a small amount) exhibited very low binding force and electrical conductivity, low capacity retention, and a very high expansion rate.

One or more embodiments may provide a negative electrode that exhibits high electrical conductivity and stable battery performance.

Example embodiments have been disclosed herein, and although specific terms are employed, they are used and are to be interpreted in a generic and descriptive sense only and not for purposes of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A negative electrode, comprising:
a current collector; and
a negative electrode active material layer on the current collector, the negative electrode active material layer comprising:
a polymer having a potential band vs. Li of less than or equal to about 1.5 V, and
a silicon active material,
wherein the negative electrode has a binding force of greater than or equal to about 1.0 gf/mm and an electrical conductivity of about 1.0 S/m to about 6.0 S/m.

2. The negative electrode as claimed in claim 1, wherein the polymer has a potential band vs. Li of less than or equal to about 1.5 V and greater than or equal to about 0.1 V.

3. The negative electrode as claimed in claim 1, wherein the polymer comprises polythiophene, poly(3,4-methylenedioxythiophene), polypyrrole, or a combination thereof.

4. The negative electrode as claimed in claim 1, wherein an amount of the polymer is about 30 wt % to about 85 wt %, based on a total weight of the negative electrode active material layer.

5. The negative electrode as claimed in claim 1, wherein an amount of the polymer is about 35 wt % to about 85 wt %, based on a total weight of the negative electrode active material layer.

6. The negative electrode as claimed in claim 1, wherein an amount of the silicon active material is about 15 wt % to about 70 wt %, based on a total weight of the negative electrode active material layer.

7. The negative electrode as claimed in claim 1, wherein an amount of the silicon active material is about 15 wt % to about 65 wt %, based on a total weight of the negative electrode active material layer.

8. The negative electrode as claimed in claim 1, wherein the silicon active material comprises a silicon material and an amorphous carbon coating layer on the silicon material.

9. The negative electrode as claimed in claim 8, wherein the silicon material comprises Si nanoparticles.

10. The negative electrode as claimed in claim 8, wherein the silicon material comprises Si, SiOₓ, in which 0<x≤2, or a combination thereof.

11. The negative electrode as claimed in claim 1, wherein the silicon active material comprises an agglomerated product in which silicon nanoparticles are agglomerated, and an amorphous carbon coating layer on a surface of the agglomerated product.

12. The negative electrode as claimed in claim 8, wherein the amorphous carbon coating layer comprises soft carbon, hard carbon, a mesophase pitch carbonized product, sintered coke, or a combination thereof.

13. The negative electrode as claimed in claim 1, wherein the negative electrode has a binding force of about 1.0 gf/mm to about 3.5 gf/mm.

14. The negative electrode as claimed in claim 1, wherein the negative electrode has an electrical conductivity of about 1.5 S/m to about 5.5 S/m.

15. A rechargeable lithium battery, comprising:
the negative electrode as claimed in claim 1;
a positive electrode comprising a positive electrode active material; and
a non-aqueous electrolyte.
